(19) United States
(12) Patent Application Publication
(10) Pub. No.: US 2026/0291102 A1
(43) Pub. Date: Sep. 24, 2026

(54) CONNECTOR AND FEMALE TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke YAMADA, Mie (JP); Katsuhiko AIZAWA, Mie (JP); Tomohiro HAYASHI, Mie (JP); Takato MIZUNO, Mie (JP)

(21) Appl. No.: 19/490,943

(22) PCT Filed: Jun. 5, 2024
(86) PCT No.: PCT/JP2024/020449

§ 371 Date: Dec. 8, 2025

(30) Foreign Application Priority Data
Jun. 9, 2023 (JP) 2023-095640

(51) Int. Cl. H01R 13/11; H01R 13/436

(52) U.S. Cl. CPC H01R 13/111; H01R 13/4361

(57) ABSTRACT

A connector includes a female terminal and a housing. The female terminal includes a first peripheral wall having a first tubular portion, a second peripheral wall having a second tubular portion facing the first tubular portion, and a tubular connecting portion composed of the first tubular portion and the second tubular portion. The female terminal includes a winding/pressing portion for limiting a separation distance between a first inner surface of the first tubular portion and a second inner surface of the second tubular portion and a convex portion projecting from an outer surface of the second peripheral wall. The winding/pressing portion is folded from the first peripheral wall while embracing an end edge of the second peripheral wall inside, and held in contact with the outer surface of the second peripheral wall.

### TECHNICAL FIELD

The present disclosure relates to a connector and a female terminal.

### BACKGROUND

Conventionally, a connector provided with a housing and a female terminal held in the housing has been known as a connector to be installed in a vehicle. A columnar connecting portion of a male terminal is inserted into and electrically connected to a tubular connecting portion of the female terminal. The female terminal of this type stably ensures a contact pressure with the columnar connecting portion of the male terminal, utilizing a biasing force by a biasing member such as a coil spring (see, for example, Patent Document 1).

### PRIOR ART DOCUMENT

### Patent Document

Patent Document 1: JP 2021-028903 A

### SUMMARY OF THE INVENTION

### Problems to be Solved

In the above connector, it is desired to suppress a displacement of the female terminal inside the housing.

The present disclosure aims to provide a connector and a female terminal capable of suppressing a displacement of the female terminal inside a housing.

### Means to Solve the Problem

The present disclosure is directed to a connector with a female terminal and a housing for holding the female terminal, the female terminal including a first peripheral wall having a first tubular portion, a second peripheral wall having a second tubular portion facing the first tubular portion, a tubular connecting portion composed of the first tubular portion and the second tubular portion, a winding/pressing portion for limiting a separation distance between a first inner surface of the first tubular portion and a second inner surface of the second tubular portion, and a convex portion projecting from an outer surface of the second peripheral wall, the winding/pressing portion being integrally formed to the first peripheral wall, the winding/pressing portion being folded from the first peripheral wall while embracing an end edge of the second peripheral wall inside, the winding/pressing portion being held in contact with the outer surface of the second peripheral wall, the winding/pressing portion and the convex portion being provided side by side on the same straight line along a first axis, and the housing including a groove-like accommodating portion, the winding/pressing portion and the convex portion being inserted into the accommodating portion.

### Effect of the Invention

According to the connector and the female terminal of the present disclosure, an effect of being able to suppress a displacement of the female terminal inside the housing is achieved.

### BRIEF DESCRIPTION OF THE DRAWINGS

FIG. 1 is a perspective view showing a wiring harness of one embodiment.

FIG. 2 is an exploded perspective view showing the wiring harness of the embodiment.

FIG. 3 is an exploded perspective view showing the wiring harness of the embodiment.

FIG. 4 is a perspective view showing a part of the wiring harness of the embodiment.

FIG. 5 is a plan view showing the part of the wiring harness of the embodiment.

FIG. 6 is a plan view showing the part of the wiring harness of the embodiment.

FIG. 7 is a section showing a part of the wiring harness of the embodiment (section along 7-7 in FIGS. 5 and 6).

FIG. 8 is a section showing a part of the wiring harness of the embodiment (section along 8-8 in FIGS. 5 and 6).

FIG. 9 is a section showing a female terminal of the embodiment (section along 9-9 in FIGS. 5 and 6).

FIG. 10 is a section showing the female terminal of the embodiment (section along 10 -10 in FIG. 9).

FIG. 11 is a perspective view in section showing the female terminal of the embodiment.

FIG. 12 is an exploded perspective view showing a part of the wiring harness of the embodiment.

FIG. 13 is a plan view showing a part of the wiring harness of the embodiment.

FIG. 14 is a section showing a part of the wiring harness of the embodiment (section along 14 -14 in FIG. 13).

FIG. 15 is a section showing a part of the wiring harness of the embodiment (section along 15-15 in FIG. 14)

### DETAILED DESCRIPTION TO EXECUTE THE INVENTION

### Description of Embodiments of Present Disclosure

First, embodiments of the present disclosure are listed and described.

[1] The connector of the present disclosure is provided with a female terminal and a housing for holding the female terminal, the female terminal including a first peripheral wall having a first tubular portion, a second peripheral wall having a second tubular portion facing the first tubular portion, a tubular connecting portion composed of the first tubular portion and the second tubular portion, a winding/pressing portion for limiting a separation distance between a first inner surface of the first tubular portion and a second inner surface of the second tubular portion, and a convex portion projecting from an outer surface of the second peripheral wall, the winding/pressing portion being integrally formed to the first peripheral wall, the winding/pressing portion being folded from the first peripheral wall while embracing an end edge of the second peripheral wall inside, the winding/pressing portion being held in contact with the outer surface of the second peripheral wall, the winding/pressing portion and the convex portion being provided side by side on the same straight line along a first axis, and the housing including a groove-like accommodating portion, the winding/pressing portion and the convex portion being inserted into the accommodating portion.

According to this configuration, the winding/pressing portion and the convex portion of the female terminal are inserted into the accommodating portion of the housing. Here, the winding/pressing portion is folded from the first peripheral wall and held in contact with the outer surface of the second peripheral wall. Thus, the winding/pressing portion projects further outward than the outer surface of the second peripheral wall. If such a winding/pressing portion is accommodated into the accommodating portion, a large gap may be formed between a part of the female terminal where the winding/pressing portion is formed and the inner surface of the accommodating portion. If such a gap is formed, a problem that the female terminal is easily displaced inside the accommodating portion occurs. In contrast, in the above configuration, the convex portion projecting from the outer surface of the second peripheral wall is provided side by side with the winding/pressing portion on the same straight line. By providing this convex portion, the gap between the part of the female terminal where the winding/pressing portion is formed and the inner surface of the accommodating portion can be reduced. In this way, a displacement of the female terminal inside the accommodating portion can be suitably suppressed. Consequently, a displacement of the female terminal inside the housing can be suitably suppressed.

[2] In [1] described above, the first peripheral wall may be formed into a strip shape extending along a first direction, the second peripheral wall may be formed into a strip shape extending along the first direction, the first inner surface may be a surface facing in a second direction intersecting the first direction, the second inner surface may be a surface facing in a second opposite direction opposite to the second direction, the outer surface of the second peripheral wall may be a surface facing in the second direction, an axial direction of the tubular connecting portion may extend along a third direction intersecting both the first direction and the second direction, the winding/pressing portion may be folded from an end surface in the third direction of the first peripheral wall while embracing an end surface in the third direction of the second peripheral wall inside, the convex portion may be provided to overlap the winding/pressing portion in a plan view viewed from the third direction, and the convex portion may project in the second direction from the outer surface of the second peripheral wall.

According to this configuration, the convex portion is formed to project in the second direction from the outer surface of the second peripheral wall. In this way, a gap between the female terminal and the inner surface of the accommodating portion can be reduced in the second direction. Therefore, the inclination of the female terminal in the second direction inside the accommodating portion can be suitably suppressed. As a result, the inclination of the axial direction of the tubular connecting portion of the female terminal in the second direction can be suppressed.

[3] In [2] described above, a first projection amount of the convex portion from the outer surface of the second peripheral wall may be equal to a second projection amount of the winding/pressing portion from the outer surface of the second peripheral wall.

According to this configuration, the first projection amount of the convex portion is equal to the second projection amount of the winding/pressing portion. By providing such a convex portion, the gap between the female terminal in the part where the winding/pressing portion is not formed and the inner surface of the accommodating portion can be made smaller. In this way, a displacement of the female terminal inside the accommodating portion can be more suitably suppressed.

[4] In [2] or [3] described above, the housing may include a housing body for accommodating the female terminal inside and a retainer to be mounted into the housing body, the retainer may include a restricting portion to be inserted into the housing body, the restricting portion restricting a movement of the female terminal, and the restricting portion may include the accommodating portion.

According to this configuration, the accommodating portion is provided in the restricting portion of the retainer. Thus, when the retainer is mounted into the housing body, a displacement of the female terminal inside the accommodating portion of the retainer can be suitably suppressed. Consequently, a displacement of the female terminal inside the housing can be suitably suppressed.

[5] In [4] described above, the restricting portion may include an engagement wall to be engaged with the convex portion in the first direction.

According to this configuration, the convex portion of the female terminal is engaged with the engagement wall in a first opposite direction opposite to the first direction. Thus, a movement of the female terminal in the first opposite direction inside the accommodating portion can be suitably suppressed.

[6] In any one of [2] to [5] described above, the female terminal may further include a coupling portion coupling the first peripheral wall and the second peripheral wall, and the coupling portion may be integrally formed to the first peripheral wall and integrally formed to the second peripheral wall.

According to this configuration, the first and second peripheral walls are coupled by the coupling portion integrally formed to the both first and second peripheral walls. In this way, the first and second peripheral walls can be integrally formed through the coupling portion. Thus, the female terminal can be configured, such as by bending one metal plate. As a result, the structure of the female terminal can be simplified.

[7] In [6] described above, the coupling portion may be formed to extend in the second direction from an end surface in a third opposite direction opposite to the third direction, out of the first peripheral wall, toward an end surface in the third opposite direction, out of the second peripheral wall, and the coupling portion may be provided to overlap the winding/pressing portion in a plan view viewed from the third direction.

According to this configuration, the winding/pressing portion is provided on a side opposite to the coupling portion across the first peripheral wall. Thus, the opening of the coupling portion, i.e. an increase in separation distance between the first and second peripheral walls, can be suitably suppressed by the winding/pressing portion. As a result, an increase in separation distance between the first inner surface constituting the tubular connecting portion and the second inner surface constituting the tubular connecting portion can be suitably limited by the winding/pressing portion.

[8] In any one of [2] to [7] described above, the female terminal may further include a protecting portion provided on an end part in the first direction of the first peripheral wall, the protecting portion may be integrally formed to the first peripheral wall, the protecting portion may be formed to be folded from the end part in the first direction of the first peripheral wall while arranging an end part in the first direction of the second peripheral wall inside, the protecting portion may include a protection wall provided to face the end part in the first direction of the second peripheral wall in the second direction, and the protection wall may be provided away from the end part in the first direction of the second peripheral wall.

According to this configuration, the protection wall of the protecting portion integrally formed to the first peripheral wall is provided to face the end part in the first direction of the second peripheral wall while being separated therefrom. Thus, for example, even if an excessive external force is accidentally applied to the end part in the first direction of the second peripheral wall and the second peripheral wall is deformed away from the first peripheral wall due to that external force, that deformation can be suitably hindered by the protection wall.

[9] In [8] described above, the winding/pressing portion may be provided on an end part in a first opposite direction opposite to the first direction, out of the first peripheral wall, the convex portion may be provided on an end part in the first opposite direction, out of the second peripheral wall, and the tubular connecting portion may be provided at an intermediate position between the winding/pressing portion and the protecting portion in the first direction.

According to this configuration, the winding/pressing portion is provided at a position different from the tubular connecting portion in the first direction. An increase in separation distance between the first and second peripheral walls can be limited by such a winding/pressing portion. Consequently, an increase in separation distance between the first inner surface constituting the tubular connecting portion and the second inner surface constituting the tubular connecting portion can be limited by the winding/pressing portion.

[10] A female terminal of the present disclosure is provided with a first peripheral wall having a first tubular portion, a second peripheral wall having a second tubular portion facing the first tubular portion, a tubular connecting portion composed of the first tubular portion and the second tubular portion, a winding/pressing portion for limiting a separation distance between a first inner surface of the first tubular portion and a second inner surface of the second tubular portion, and a convex portion projecting from an outer surface of the second peripheral wall, the winding/pressing portion being integrally formed to the first peripheral wall, the winding/pressing portion being folded from the first peripheral wall while embracing an end edge of the second peripheral wall inside, the winding/pressing portion being held in contact with the outer surface of the second peripheral wall, and the winding/pressing portion and the convex portion being provided side by side on the same straight line along a first axis.

According to this configuration, effects similar to those of the connector of [1] described above can be obtained.

### Details of Embodiment of Present Disclosure

Specific examples of a connector and a female terminal of the present disclosure are described below with reference to the drawings. For the convenience of description, some components may be shown in an exaggerated or simplified manner in each drawing. Further, a dimension ratio of each part may be different in each figure. “Parallel” and “orthogonal” in this specification mean not only strictly parallel and orthogonal, but also substantially parallel and orthogonal within a range in which functions and effects in this embodiment are achieved. In this specification, a term “equal” also means a case where objects to be compared are slightly different due to dimensional tolerances and the like, in addition to meaning exactly equal. A term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape and a U shape. Note that “tubular” shapes include circular shapes, elliptical shapes and polygonal shapes with angular or round corners, but there is no limitation to these. “Facing each other” in this specification indicates that surfaces or members are at positions in front of each other, and means not only a case where the surfaces or members are at positions perfectly in front of each other, but also a case where the surfaces or members are partially in front of each other. Further, “facing each other” in this specification means both a case where another member different from two parts is interposed between the two parts and a case where nothing is interposed between the two parts. Further, terms such as “first”, “second” and “third” in this specification are merely used to distinguish objects and do not rank the objects. Note that the present invention is not limited to these illustrations, but is represented by claims and intended to include all changes in the scope of claims and in the meaning and scope of equivalents.

### Overall Configuration of Wiring Harness W1

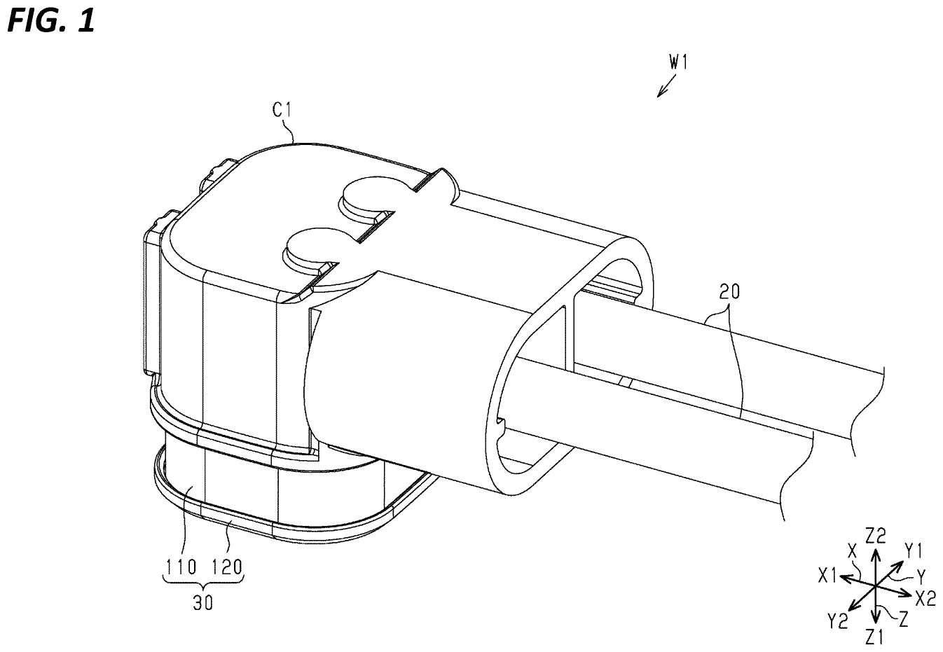

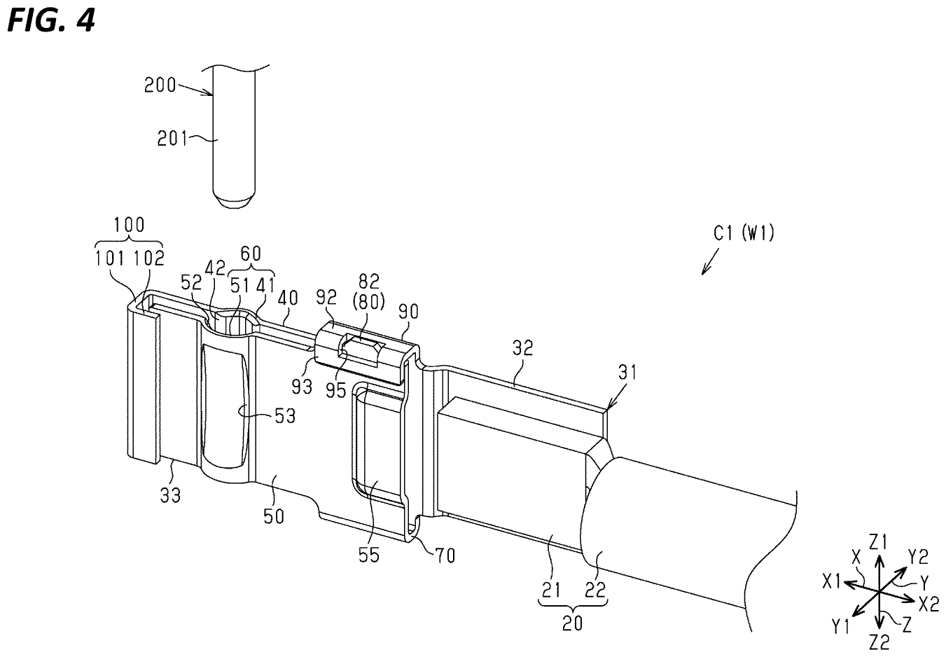

As shown in FIG. 1, a wiring harness W1 is provided with one or more (two in this embodiment) wires 20 and a connector C1 mounted on end parts of the wires 20. The wiring harness W1 is, for example, for electrically connecting electrical devices for vehicle. An inverter and a wheel drive motor can be, for example, cited as the electrical devices for vehicle. Although not shown in detail, the connector C1 is electrically connected to a mating connector provided on the electrical device. The mating connector is provided with one or more (two in this embodiment) male terminals 200 as mating terminals (see FIG. 4) and a mating housing for holding the two male terminals 200. Note that respective directions in each figure do not necessarily indicate the postures of the connector C1 and the wiring harness W1 during usage.

### (Overall Configuration of Connector C1)

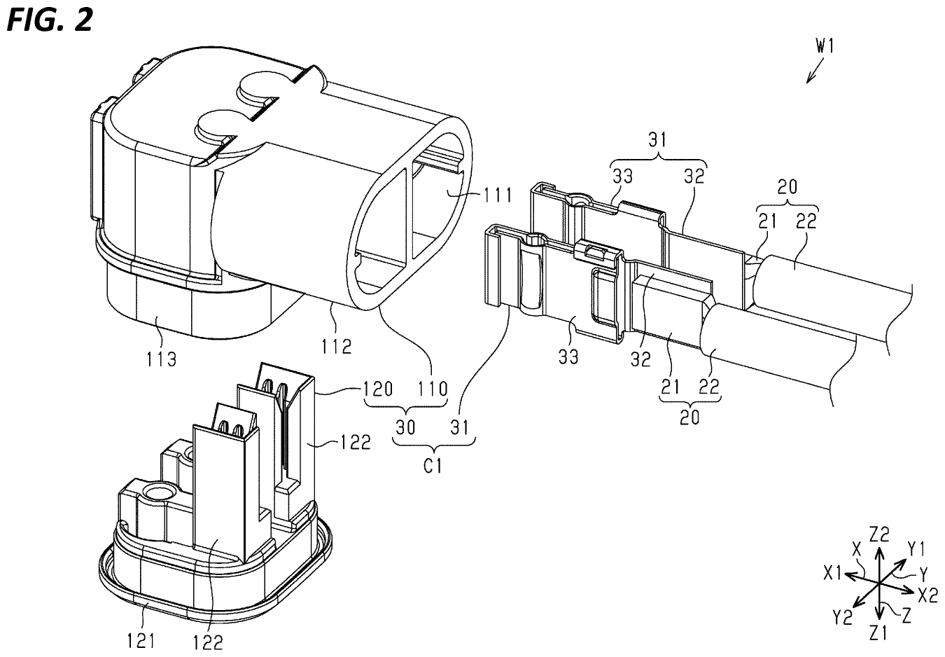

As shown in FIG. 2, the connector C1 is provided with a housing 30 and a plurality of female terminals 31 respectively connected to end parts of a plurality of wires 20. The housing 30 holds a plurality of the female terminals 31. The housing 30 includes a housing body 110 for accommodating the female terminals 31 inside and a retainer 120 to be mounted into the housing body 110. Note that an X axis, a Y axis and a Z axis orthogonal to each other are shown in each figure. In each figure, a first direction X1, which is one of X-axis directions along the X axis, and a first opposite direction X2, which is a direction opposite to the first direction X1, are shown. In each figure, a second direction Y1, which is one of Y-axis directions along the Y axis, and a second opposite direction Y2, which is a direction opposite to the second direction Y1, are shown. In each figure, a third direction Z1, which is one of Z-axis directions along the Z axis, and a third opposite direction Z2, which is a direction opposite to the third direction Z1, are shown. Each direction described above is a direction in a state where the connector C1 is mounted on the end parts of the wires 20 unless otherwise specified.

The female terminals 31 and the wires 20 are inserted into the housing body 110 along the first direction X1. The retainer 120 is mounted into the housing body 110 along the third opposite direction Z2. The mating connector is connected to the connector C1, for example, along the third opposite direction Z2. For example, the male terminals 200 (see FIG. 4) of the mating connector are inserted into the housing body 110 along the third opposite direction Z2.

### Configuration of Wire 20

Each wire 20 includes an electrically conductive core wire 21 and an insulating insulation coating 22 surrounding the outer periphery of the core wire 21. A stranded wire formed by twisting a plurality of metal strands or a single core wire constituted by a single conductor can be, for example, used as the core wire 21. A copper-based or aluminum-based metal material can be, for example, used as a material of the core wire 21. The insulation coating 22 covers, for example, the outer peripheral surface of the core wire 21 over the entire periphery in a circumferential direction. The insulation coating 22 is, for example, made of an insulating resin material.

An end part in the first direction X1 of the core wire 21 is exposed from the insulation coating 22. The female terminal 31 is connected to the end part in the first direction X1 of the core wire 21 exposed from the insulation coating 22.

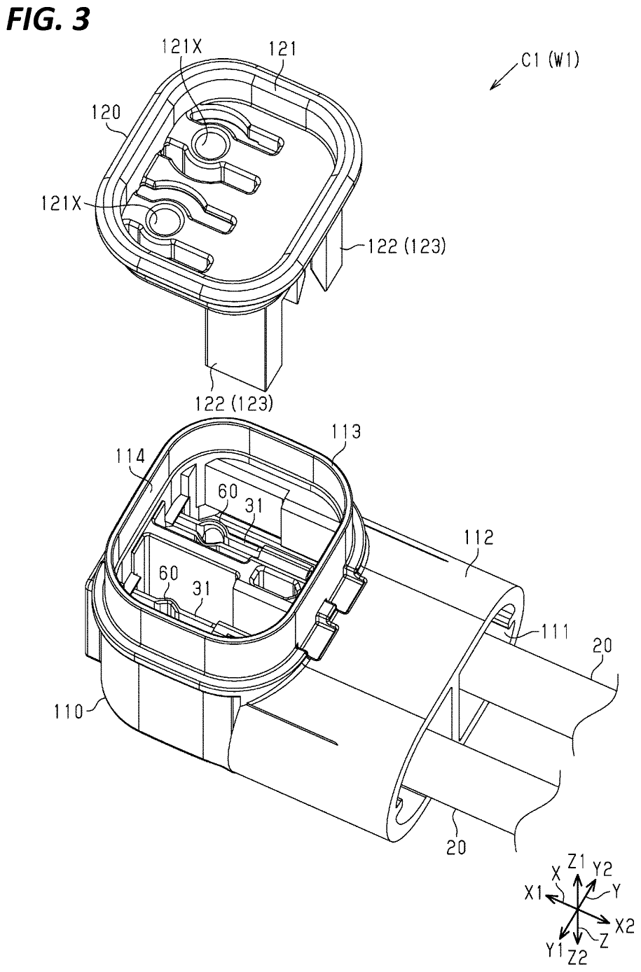

As shown in FIG. 3, an end part in the first direction X1 of the wire 20 is accommodated inside the housing body 110. The wire 20 is drawn out in the first opposite direction X2 from an end part in the first opposite direction X2 of the housing body 110.

### Configuration of Female Terminals 31

As shown in FIG. 2, the two female terminals 31 are respectively electrically connected to the two wires 20. The two female terminals 31 are provided side by side along the Y-axis direction. The two female terminals 31 have, for example, the same structure. Here, description is given, focusing on the female terminal 31 provided on the second direction Y1 side, out of the two female terminals 31.

Each female terminal 31 includes a wire connecting portion 32 to be connected to the end part of the wire 20 and a terminal connecting portion 33 extending in the first direction X1 from an end part in the first direction X1 of the wire connecting portion 32. Each female terminal 31 is, for example, a single component in which the wire connecting portion 32 and the terminal connecting portion 33 are continuously and integrally formed. Each female terminal 31 is configured, for example, by bending a metal plate material or combining metal plate materials. Each female terminal 31 of this embodiment is configured by bending one metal plate material. Each female terminal 31 is, for example, made of metal. A copper-based or aluminum-based metal material can be, for example, used as a material of each female terminal 31.

The wire connecting portion 32 is connected to the end part of the core wire 21 exposed from the insulation coating 22. The wire connecting portion 32 is, for example, in the form of a flat plate. The wire connecting portion 32 is, for example, in the form of a stipe extending along the X-axis direction. The wire connecting portion 32 is, for example, connected to the core wire 21 by crimping, ultrasonic welding or the like. In this way, the wire connecting portion 32 and the core wire 21 are electrically and mechanically connected.

As shown in FIG. 4, the terminal connecting portion 33 is a female terminal portion to be connected to the male terminal 200 of the mating connector. Here, the male terminal 200 includes a column-like columnar connecting portion 201. The columnar connecting portion 201 of this embodiment is formed into a cylindrical shape.

The terminal connecting portion 33 includes a first peripheral wall 40 having a first tubular portion 41 and a second peripheral wall 50 having a second tubular portion 51 facing the first tubular portion 41. The terminal connecting portion 33 includes a tubular connecting portion 60 composed of the first and second tubular portions 41, 51. The terminal connecting portion 33 includes, for example, a coupling portion 70, a projecting portion 80, a winding/pressing portion 90 and a protecting portion 100. The first and second peripheral walls 40, 50 are facing each other in the Y-axis direction.

### Configurations of First Peripheral Wall 40 and Second Peripheral Wall 50

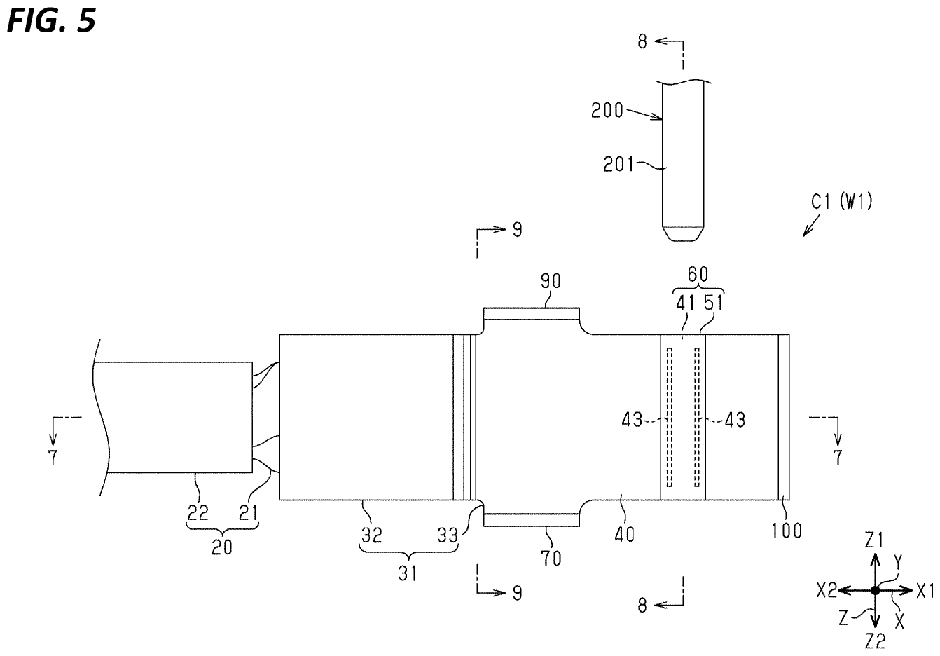

As shown in FIGS. 4 and 5, an end part in the first opposite direction X2 of the first peripheral wall 40 is connected to the end part in the first direction X1 of the wire connecting portion 32. The first peripheral wall 40 is in the form of a strip extending along the first direction X1. The first peripheral wall 40 extends, for example, in the first direction X1 from the end part in the first direction X1 of the wire connecting portion 32. In other words, the wire connecting portion 32 extends in the first opposite direction X2 from an end part in the first opposite direction X2 of the first peripheral wall 40. The first peripheral wall 40 is, for example, in the form of a flat plate. The first peripheral wall 40 has a predetermined width along the Z-axis direction. As shown in FIG. 4, the first peripheral wall 40 has a predetermined thickness along the Y-axis direction. The first peripheral wall 40 has an inner surface facing the second peripheral wall 50 and an outer surface provided on a side opposite to the inner surface in the Y-axis direction.

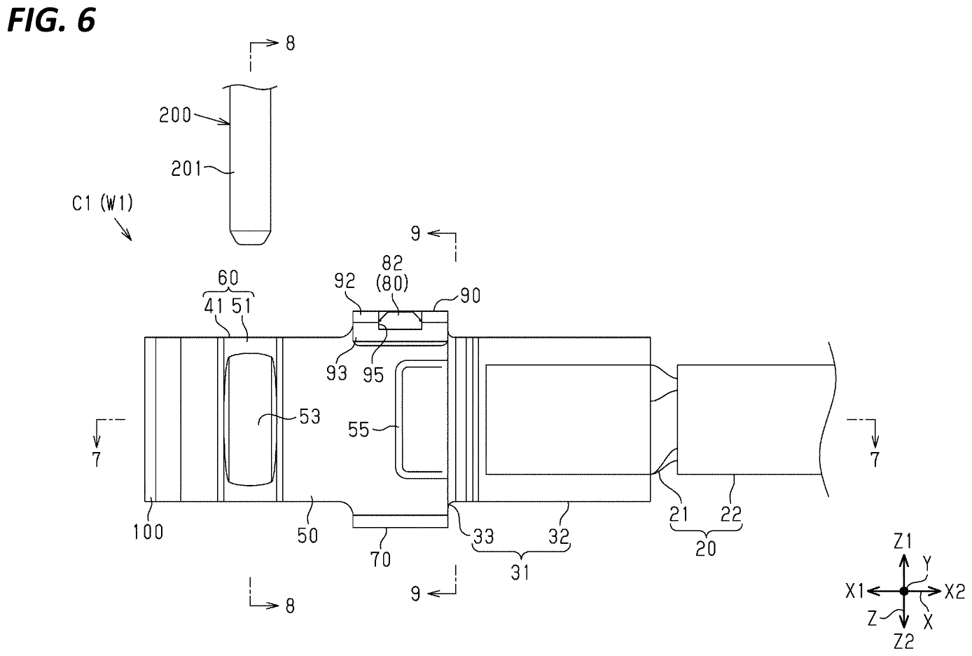

As shown in FIGS. 4 and 6, the second peripheral wall 50 is in the form of a strip extending along the first direction X1. The second peripheral wall 50 is, for example, in the form of a flat plate. The second peripheral wall 50 has a predetermined width along the Z-axis direction. As shown in FIG. 4, the second peripheral wall 50 has a predetermined thickness along the Y-axis direction. The second peripheral wall 50 has an inner surface facing the inner surface of the first peripheral wall 40 and an outer surface provided on a side opposite to the inner surface in the Y-axis direction. The inner surface of the second peripheral wall 50 is, for example, provided away from the inner surface of the first peripheral wall 40 in the Y-axis direction. The second peripheral wall 50 extends, for example, in parallel to the first peripheral wall 40.

The first tubular portion 41 is provided at an intermediate position in the X-axis direction of the first peripheral wall 40. The first tubular portion 41 is provided between the winding/pressing portion 90 and the protecting portion 100 in the X-axis direction. The first tubular portion 41 is, for example, formed into a half tube shape as a whole. As shown in FIG. 5, the first tubular portion 41 extends along the Z-axis direction. The first tubular portion 41 extends over the entire length in the Z-axis direction of the first peripheral wall 40.

As shown in FIG. 4, the second tubular portion 51 is provided at an intermediate position in the X-axis direction of the second peripheral wall 50. The second tubular portion 51 is provided between the winding/pressing portion 90 and the protecting portion 100 in the X-axis direction. The second tubular portion 51 is, for example, formed into a half tube shape as a whole. The second tubular portion 51 extends along the Z-axis direction. The second tubular portion 51 extends over the entire length in the Z-axis direction of the second peripheral wall 50.

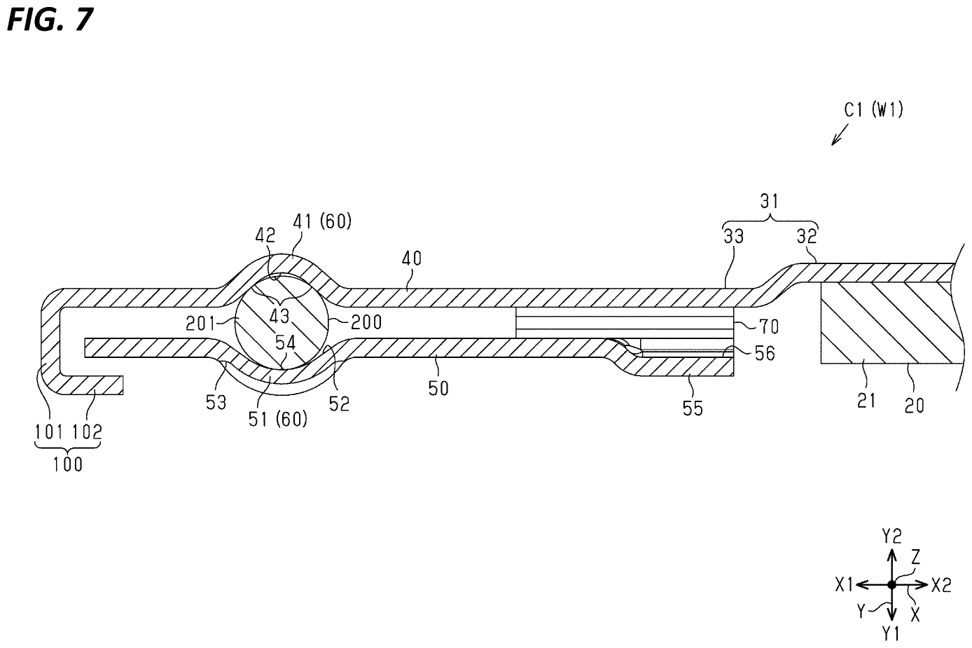

As shown in FIG. 7, the first tubular portion 41 has a first inner surface 42 facing in the second direction Y1. The second tubular portion 51 has a second inner surface 52 facing in the second opposite direction Y2. The first and second inner surfaces 42, 52 are facing each other in the Y-axis direction. The first and second tubular portions 41, 51 are curved in directions separating from each other. An internal space of the tubular connecting portion 60 is formed by the first inner surface 42 of the first tubular portion 41 and the second inner surface 52 of the second tubular portion 51. The tubular connecting portion 60 is a connecting part, into which the columnar connecting portion 201 of the male terminal 200 is inserted and which is electrically connected to the columnar connecting portion 201. As shown in FIG. 4, an axial direction of the tubular connecting portion 60 is a direction intersecting an extension direction of the wire 20 (here, the X-axis direction) and, in this embodiment, extends along the Z-axis direction. The tubular connecting portion 60 is open on both ends in the Z-axis direction. That is, the tubular connecting portion 60 is open in the third direction Z1 and also in the third opposite direction Z2. The columnar connecting portion 201 is inserted into the tubular connecting portion 60 of this embodiment along the third opposite direction Z2.

As shown in FIG. 7, the tubular connecting portion 60 is, for example, formed into a hollow cylindrical portion as a whole. The tubular connecting portion 60 has, for example, a minimum inner diameter smaller than a maximum outer diameter of the columnar connecting portion 201. That is, the tubular connecting portion 60 is so configured that the columnar connecting portion 201 is press-fit thereinto.

The outer surface of the first tubular portion 41 is formed into a curved surface having an arcuate cross-sectional shape obtained by cutting the first tubular portion 41 by a plane parallel to the X-axis direction. The outer surface of the first tubular portion 41 is formed to arcuately project radially outwardly of the tubular connecting portion 60 in a cross-section. Similarly, the first inner surface 42 of the first tubular portion 41 is formed to be arcuately recessed radially outwardly of the tubular connecting portion 60 in a cross-section.

The first inner surface 42 of the first tubular portion 41 is provided with a plurality of (two in this embodiment) linear contact portions 43 projecting radially inwardly of the tubular connecting portion 60 from the inner surface 42. The two linear contact portions 43 are provided at positions separated from each other in a circumferential direction of the tubular connecting portion 60. The two linear contact portions 43 are, for example, provided to partially face each other in the X-axis direction. As shown in FIG. 5, each linear contact portion 43 extends along the axial direction of the tubular connecting portion 60 (here, the Z-axis direction).

As shown in FIG. 7, a curvature of the first inner surface 42 having the two linear contact portions 43 is set to be smaller than that of the outer peripheral surface of the columnar connecting portion 201 of the male terminal 200. In this way, the two linear contact portions 43 can be suitably brought into contact with the outer peripheral surface of the columnar connecting portion 201. At this time, each linear contact portion 43 is linearly held in contact with the outer peripheral surface of the columnar connecting portion 201 along the axial direction of the tubular connecting portion 60. That is, each linear contact portion 43 linearly contacts the outer peripheral surface of the columnar connecting portion 201.

The outer surface of the second tubular portion 51 is formed into a curved surface having an arcuate cross-sectional shape obtained by cutting the second tubular portion 51 by a plane parallel to the X-axis direction. The outer surface of the second tubular portion 51 is formed to arcuately project radially outwardly of the tubular connecting portion 60 in a cross-section. Similarly, the second inner surface 52 of the second tubular portion 51 is formed to be arcuately recessed radially outwardly of the tubular connecting portion 60 in a cross-section.

As shown in FIGS. 4 and 6, the outer surface of the second tubular portion 51 is provided with a dent portion 53 dented radially inwardly of the tubular connecting portion 60 from the outer surface. As shown in FIG. 6, the dent portion 53 is, for example, formed into a rectangular planar shape when viewed from the Y-axis direction. The dent portion 53 is, for example, provided at an intermediate position in the Z-axis direction of the second tubular portion 51 and at an intermediate position in the X-axis direction of the second tubular portion 51.

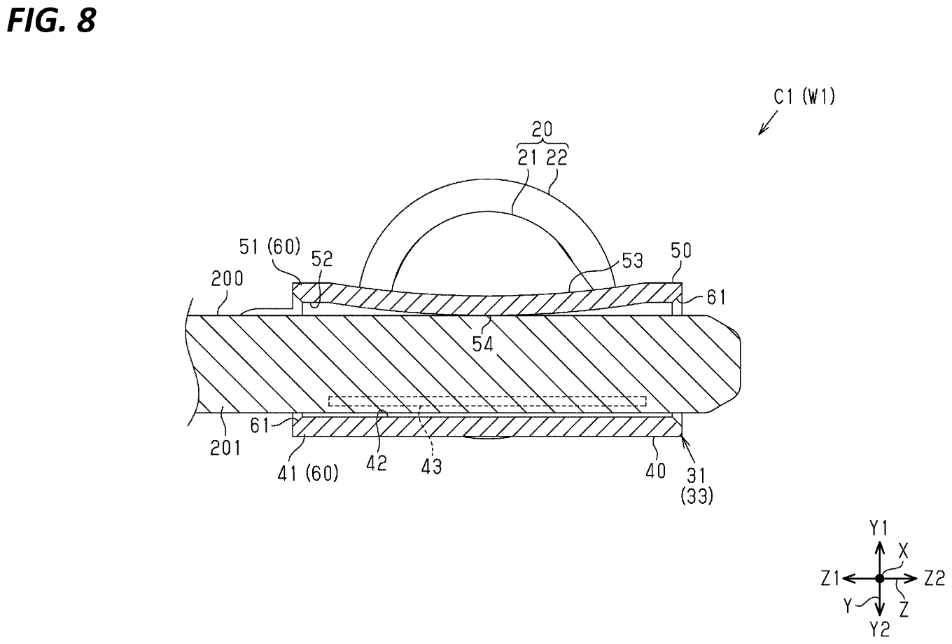

As shown in FIG. 8, the second inner surface 52 of the second tubular portion 51 is provided with a protrusion 54 projecting radially inwardly of the tubular connecting portion 60 from the second inner surface 52. The protrusion 54 is, for example, provided on the second inner surface 52 of the second tubular portion 51 in a part where the dent portion 53 is formed. The protrusion 54 is, for example, formed to have a cross-sectional shape obtained by cutting the protrusion 54 by a plane parallel to the axial direction of the tubular connecting portion 60 (here, the Z-axis direction) and arcuately projecting radially inwardly of the tubular connecting portion 60. The protrusion 54 is formed to arcuately project radially inwardly of the tubular connecting portion 60 from the second inner surface 52 in a cross-section. The protrusion 54 extends, for example, along the circumferential direction of the tubular connecting portion 60. The protrusion 54 extends, for example, along the axial direction of the tubular connecting portion 60. The protrusion 54 is in point contact with the outer peripheral surface of the columnar connecting portion 201 of the male terminal 200. The protrusion 54 can be, for example, formed by embossing. The protrusion 54 is formed into an embossed shape by pressurizing the outer surface of the second tubular portion 51 by a die.

Each of both end parts in the axial direction of the tubular connecting portion 60 includes, for example, a guiding portion 61. Each guiding portion 61 is formed to increase an opening width (here, an inner diameter) of the tubular connecting portion 60 toward an opening end in the axial direction of the tubular connecting portion 60. Each guiding portion 61 is, for example, formed by inclining the inner surface of the tubular connecting portion 60 radially outwardly of the tubular connecting portion 60 toward the opening end of the tubular connecting portion 60. Each guiding portion 61 is, for example, formed over the entire periphery in the circumferential direction of the first inner surface 42 of the first tubular portion 41 and formed over the entire periphery in the circumferential direction of the second inner surface 52 of the second tubular portion 51. Each guiding portion 61 functions to smoothly guide the columnar connecting portion 201 into the tubular connecting portion 60 when the columnar connecting portion 201 of the male terminal 200 is inserted into the tubular connecting portion 60. Since such guiding portions 61 are provided on the both end parts in the axial direction of the tubular connecting portion 60, insertion resistance can be caused to similarly change, regardless of in which of the both end parts in the axial direction of the tubular connecting portion 60 an insertion opening into the tubular connecting portion 60 for the male terminal 200 is set. Thus, the limitation of an insertion direction of the male terminal 200 with respect to the axial direction of the tubular connecting portion 60 can be eliminated.

As shown in FIG. 4, the second peripheral wall 50 includes a convex portion 55 projecting from the outer surface of the second peripheral wall 50. The convex portion 55 projects in the second direction Y1 from the outer surface of the second peripheral wall 50. The convex portion 55 is provided side by side with the winding/pressing portion 90 on the same straight line along the Z axis (first axis). The convex portion 55 is provided at a position overlapping the winding/pressing portion 90 in a plan view viewed from the third direction Z1. The convex portion 55 is, for example, provided on an end part in the first opposite direction X2 of the second peripheral wall 50. The convex portion 55 extends, for example, in the first direction X1 from an end surface in the first opposite direction X2 of the second peripheral wall 50. The convex portion 55 does not extend up to the second tubular portion 51 in the X-axis direction. The convex portion 55 is, for example, provided at an intermediate position in the Z-axis direction of the second peripheral wall 50. The convex portion 55 is, for example, formed into a rectangular planar shape when viewed from the Y-axis direction. The convex portion 55 can be, for example, formed by embossing. The convex portion 55 is formed into an embossed shape by pressurizing the inner surface of the second peripheral wall 50 by a die.

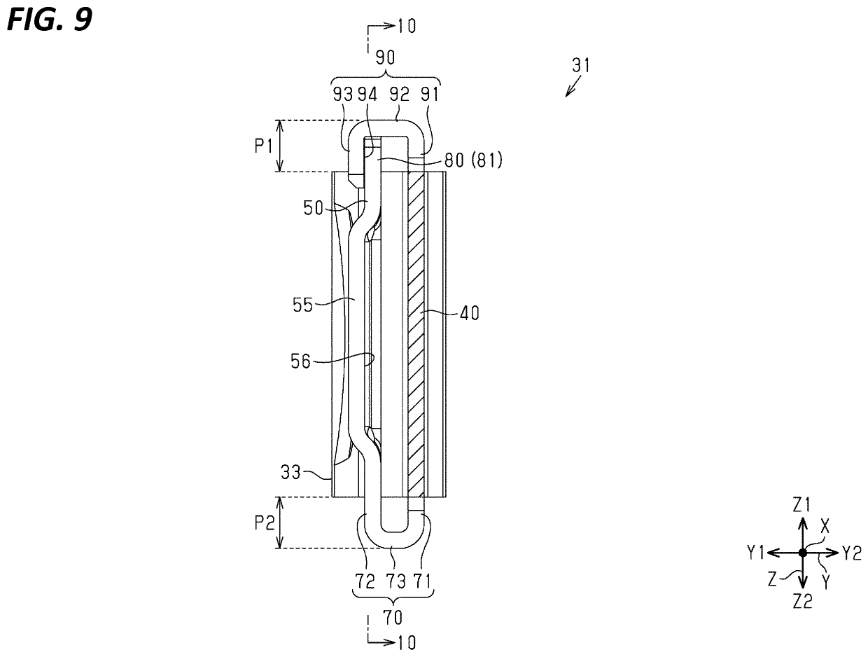

As shown in FIG. 9, the second peripheral wall 50 is provided with a concave portion 56 in the inner surface of a part where the convex portion 55 is formed. The concave portion 56 is formed to be recessed in a direction separating from the first peripheral wall 40 from the inner surface of the second peripheral wall 50.

### Configuration of Coupling Portion 70

As shown in FIG. 4, the coupling portion 70 couples the first and second peripheral walls 40, 50. The coupling portion 70 couples an end part in the third opposite direction Z2 of the first peripheral wall 40 and an end part in the third opposite direction Z2 of the second peripheral wall 50. The coupling portion 70 is integrally formed to the first peripheral wall 40 and integrally formed to the second peripheral wall 50. The coupling portion 70 is formed to extend in the second direction Y1 from an end surface in the third opposite direction Z2 of the first peripheral wall 40 to an end surface in the third opposite direction Z2 of the second peripheral wall 50. The coupling portion 70 is formed by being folded from the end surface in the third opposite direction Z2 of the first peripheral wall 40 toward the end surface in the third opposite direction Z2 of the second peripheral wall 50.

The coupling portion 70 is, for example, provided on an end part in the first opposite direction X2 of the terminal connecting portion 33. The coupling portion 70 is provided on an end part in the first opposite direction X2 of the first peripheral wall 40. The coupling portion 70 extends in the first direction X1 from the end part in the first opposite direction X2 of the first peripheral wall 40. The coupling portion 70 projects further in the third opposite direction Z2 than the end surface in the third opposite direction Z2 of the first peripheral wall 40 and projects further in the third opposite direction Z2 than the end surface in the third opposite direction Z2 of the second peripheral wall 50.

As shown in FIG. 9, the coupling portion 70 includes an extending portion 71 extending in the third opposite direction Z2 from the end surface in the third opposite direction Z2 of the first peripheral wall 40 and an extending portion 72 extending in the third opposite direction Z2 from the end surface in the third opposite direction Z2 of the second peripheral wall 50. The coupling portion 70 includes a folded portion 73 linking the extending portions 71, 72.

The extending portion 71 is formed to be continuous and integral with the first peripheral wall 40. The folded portion 73 is formed to be continuous and integral with the extending portion 71. The folded portion 73 is formed to be folded toward the second peripheral wall 50 from an end part of the extending portion 71. The folded portion 73 is, for example, folded in the third direction Z1 into a U shape from the end part of the extending portion 71. The extending portion 72 extends in the third direction Z1 from the folded portion 73 toward the second peripheral wall 50. The extending portion 72 is formed to be continuous and integral with the folded portion 73 and formed to be continuous and integral with the second peripheral wall 50. The coupling portion 70 is folded into a U shape convex in a direction separating from the first and second peripheral walls 40, 50 (here, in the third opposite direction Z2) by the extending portion 71, the folded portion 73 and the extending portion 72. The coupling portion 70 is so folded that the second peripheral wall 50 is arranged to face the first peripheral wall 40. In other words, in the terminal connecting portion 33, the second peripheral wall 50 is folded into two toward the first peripheral wall 40 by the coupling portion 70.

### Configuration of Projecting Portion 80

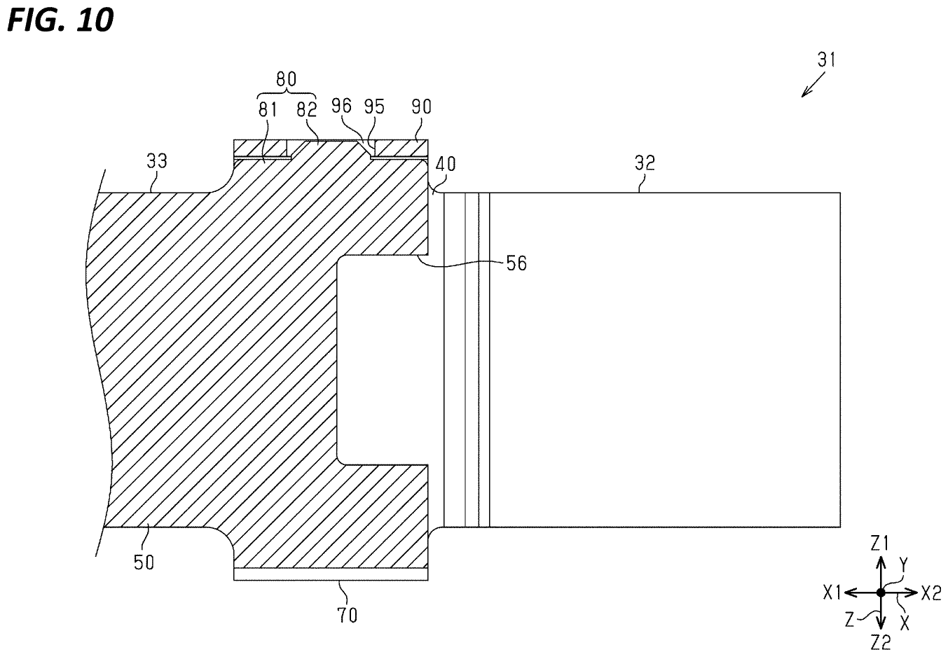

As shown in FIG. 10, the projecting portion 80 is provided on an end surface in the third direction Z1 of the second peripheral wall 50. The projecting portion 80 includes, for example, a projecting base portion 81 extending in the third direction Z1 from the end surface in the third direction Z1 of the second peripheral wall 50 and a projection 82 extending in the third direction Z1 from a part of the projecting tip surface of the projecting base portion 81. The projecting base portion 81 is formed to be continuous and integral with the second peripheral wall 50. The projecting base portion 81 extends along the first direction X1 from an end surface in the first opposite direction X2 of the second peripheral wall 50. The projection 82 is formed to be continuous and integral with the projecting base portion 81. The projection 82 projects further in the third direction Z1 than the projecting tip surface, here, the end surface in the third direction Z1, of the projecting base portion 81. The projection 82 is, for example, provided only at an intermediate position in the X-axis direction of the projecting base portion 81. The projection 82 is, for example, formed to reduce a width along the X-axis direction toward the projecting tip surface of the projection 82 from the projecting base portion 81 in a plan view viewed from the Y-axis direction.

### Configuration of Winding/Pressing Portion 90

As shown in FIG. 4, the winding/pressing portion 90 is formed to limit a separation distance between the first inner surface 42 of the first tubular portion 41 and the second inner surface 52 of the second tubular portion 51. The winding/pressing portion 90 limits an increase in separation distance between the first and second inner surfaces 42, 52. The winding/pressing portion 90 limits the opening of the coupling portion 70. The winding/pressing portion 90 is integrally formed to the first peripheral wall 40. The winding/pressing portion 90 is, for example, provided on the end part in the third direction Z1 of the first peripheral wall 40. The winding/pressing portion 90 is, for example, formed to be folded from the first peripheral wall 40 while embracing an end edge of the second peripheral wall 50 inside. The winding/pressing portion 90 is, for example, formed to be folded from the end surface in the third direction Z1 of the first peripheral wall 40 while arranging the end surface in the third direction Z1 of the second peripheral wall 50 inside. The winding/pressing portion 90 is in contact with the outer surface of the second peripheral wall 50.

The winding/pressing portion 90 is, for example, provided on the end part in the first opposite direction X2 of the terminal connecting portion 33. The winding/pressing portion 90 is provided on the end part in the first opposite direction X2 of the first peripheral wall 40. The winding/pressing portion 90 extends in the first direction X1 from the end part in the first opposite direction X2 of the first peripheral wall 40. The winding/pressing portion 90 is provided at a position overlapping the coupling portion 70 in a plan view viewed from the third direction Z1. For example, the winding/pressing portion 90 is provided on a side opposite to the coupling portion 70 across the first peripheral wall 40 in the Z-axis direction.

As shown in FIG. 9, the winding/pressing portion 90 includes an extending portion 91 extending in the third direction Z1 from the end surface in the third direction Z1 of the first peripheral wall 40, a folded portion 92 provided on an end part of the extending portion 91 and a pressing portion 93 extending from an end part of the folded portion 92 toward the second peripheral wall 50.

The extending portion 91 is formed to be continuous and integral with the first peripheral wall 40. The folded portion 92 is formed to be continuous and integral with the extending portion 91. The folded portion 92 is formed to be folded toward the second peripheral wall 50 from an end part in the third direction Z1 of the extending portion 91. The folded portion 92 is, for example, folded in the third opposite direction Z2 into a U shape from the end part of the extending portion 91. The pressing portion 93 is formed to be continuous and integral with the folded portion 92. The pressing portion 93 extends in the third opposite direction Z2 from the folded portion 92 toward the projecting portion 80 and the second peripheral wall 50. The winding/pressing portion 90 is folded into a U shape convex in a direction separating from the first and second peripheral walls 40, 50 (here, the third direction Z1) by the extending portion 91, the folded portion 92 and the pressing portion 93.

The pressing portion 93 is provided to press the outer surface of the second peripheral wall 50 from outside. The pressing portion 93 is, for example, provided to press the outer surface of the projecting base portion 81 from outside. The pressing portion 93 has a facing surface 94 facing the outer surface of the second peripheral wall 50. The facing surface 94 extends, for example, in parallel to the outer surface of the second peripheral wall 50. The facing surface 94 is, for example, in surface contact with the outer surface of the second peripheral wall 50.

Here, a projection amount P1 of the winding/pressing portion 90 from the end surface in the third direction Z1 of the first peripheral wall 40 is, for example, equal to a projection amount P2 of the coupling portion 70 from the end surface in the third opposite direction Z2 of the first peripheral wall 40. The projection amount Pl is a longest distance along the Z-axis direction from the end surface in the third direction Z1 of the first peripheral wall 40 to the projecting tip of the winding/pressing portion 90. The projection amount P2 is a longest distance along the Z-axis direction from the end surface in the third opposite direction Z2 of the first peripheral wall 40 to the projecting tip of the coupling portion 70. A length of the folded portion 92 along the Y-axis direction is, for example, larger than that of the folded portion 73 along the Y-axis direction by a thickness of the second peripheral wall 50.

A first projection amount of the convex portion 55 from the outer surface of the second peripheral wall 50 is, for example, equal to a second projection amount of the winding/pressing portion 90 from the outer surface of the second peripheral wall 50. That is, the convex portion 55 is so formed that the projection amount from the outer surface of the second peripheral wall 50 is equal to that of the winding/pressing portion 90. The first projection amount is a longest distance along the Y-axis direction from the outer surface of the second peripheral wall 50 to the projecting tip of the convex portion 55. The second projection amount is a longest distance along the Y-axis direction from the outer surface of the second peripheral wall 50 to the projecting tip of the winding/pressing portion 90.

As shown in FIG. 4, the winding/pressing portion 90 includes a through hole 95, into which the projection 82 is fit. The through hole 95 penetrates through the winding/pressing portion 90 in a thickness direction. The through hole 95 extends, for example, from an intermediate position of the folded portion 92 to an intermediate position of the pressing portion 93. The through hole 95 is formed in a size fittable to the projection 82.

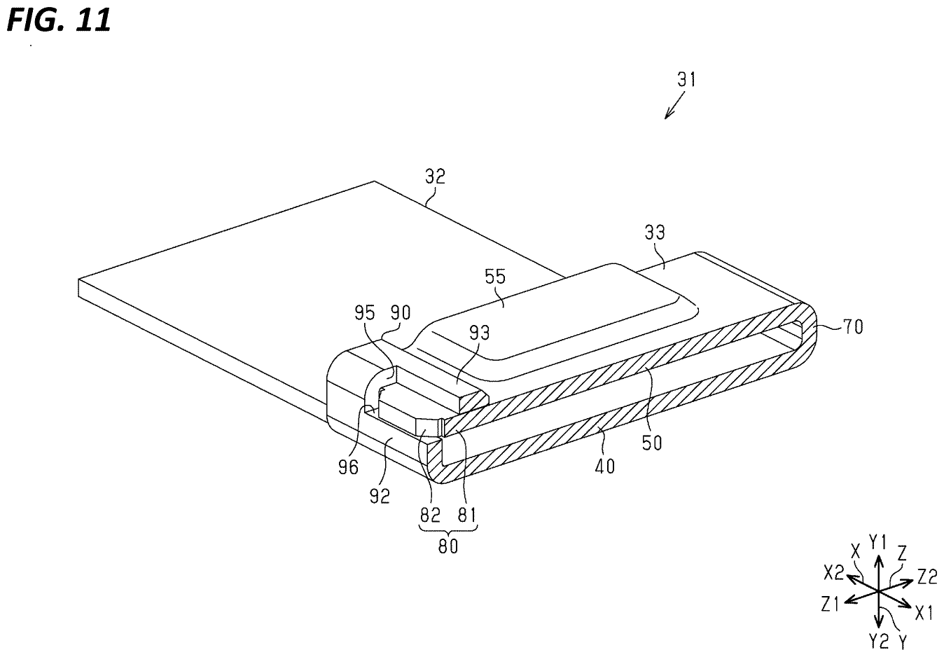

As shown in FIG. 11, the winding/pressing portion 90 has an engagement surface 96 constituting the through hole 95 and to be engaged with the projection 82. The engagement surface 96 is, for example, facing in the second direction Y1. The engagement surface 96 is facing the inner surface of the projection 82 in the Y-axis direction. The engagement surface 96 extends, for example, in parallel to the inner surface of the projection 82. The engagement surface 96 is, for example, in surface contact with the inner surface of the projection 82. The outer surface of the projection 82 is, for example, exposed from the winding/pressing portion 90 through the through hole 95.

In the terminal connecting portion 33 of this embodiment, the outer surface of the second peripheral wall 50 is pressed from outside by the pressing portion 93 of the winding/pressing portion 90, and the engagement surface 96 of the winding/pressing portion 90 is pressed from outside by the projection 82 of the projecting portion 80. In this way, an increase in separation distance between the first and second peripheral walls 40, 50 can be stably limited.

### Configuration of Protecting Portion 100

As shown in FIG. 4, the protecting portion 100 is, for example, provided to protect an end part in the first direction X1 of the terminal connecting portion 33. The protecting portion 100 is provided on the end part in the first direction X1 of the first peripheral wall 40. The protecting portion 100 is, for example, integrally formed to the first peripheral wall 40. The protecting portion 100 is formed to be folded from the end part in the first direction X1 of the first peripheral wall 40 while arranging the end part in the first direction X1 of the second peripheral wall 50 inside.

The protecting portion 100 includes an extending portion 101 extending in the second direction Y1 from the end part in the first direction X1 of the first peripheral wall 40 and a protection wall 102 extending toward the second peripheral wall 50 from an end part in the second direction Y1 of the extending portion 101. The extending portion 101 is formed to be continuous and integral with the first peripheral wall 40. The protection wall 102 is formed to be continuous and integral with the extending portion 101. The protecting portion 100 is folded into a U shape convex in a direction separating from the second peripheral wall 50 (here, in the first direction X1) by the extending portion 101 and the protection wall 102. The protection wall 102 is provided to face the end part in the first direction X1 of the second peripheral wall 50 in the Y-axis direction. The protection wall 102 is provided away from the outer surface of the second peripheral wall 50. That is, a gap is provided between the protection wall 102 and the outer surface of the second peripheral wall 50. The protection wall 102 is, for example, provided away from the outer surface of the second peripheral wall 50 with the columnar connecting portion 201 inserted in the tubular connecting portion 60. Note that a length of the extending portion 101 along the Y-axis direction is larger than that of the folded portion 92 along the Y-axis direction.

### Configuration of Housing Body 110

As shown in FIG. 3, the housing body 110 holds the female terminals 31 such that the wires 20 are drawn out in the first opposite direction X2. The housing body 110 accommodates the two female terminals 31 inside. The housing body 110 is, for example, formed into a box shape as a whole. The housing body 110 is, for example, made of synthetic resin.

The housing body 110 includes an opening 111 open in the first opposite direction X2. The wire 20 connected to the female terminal 31 is pulled out to the outside of the housing body 110 through the opening 111. The housing body 110 includes, for example, a peripheral wall 112 provided in the third direction Z1 and a tube portion 113 provided on the outer surface of the peripheral wall 112. The tube portion 113 is a fitting tube portion, to which a mating housing of the unillustrated mating connector is fit. The tube portion 113 is provided on an end part in the first direction X1 of the peripheral wall 112. The tube portion 113 projects radially outwardly of the housing body 110 (here, in the third direction Z1) from the outer surface of the peripheral wall 112. The tube portion 113 is, for example, formed into a rectangular tube shape.

The tube portion 113 includes an insertion hole 114. The insertion hole 114 is formed to allow communication between the inside and outside of the housing body 110. The insertion hole 114 is open in the third direction Z1 and also in the third opposite direction Z2. For example, the insertion hole 114 penetrates through the tube portion 113 in the Z-axis direction and penetrates through the peripheral wall 112 in the Z-axis direction. The insertion hole 114 is formed to expose the female terminals 31 accommodated in the housing body 110. Here, each female terminal 31 accommodated inside the housing body 110 is so provided that an opening end of the tubular connecting portion 60 is exposed through the insertion hole 114.

### Configuration of Retainer 120

The retainer 120 is mounted into the tube portion 113 of the housing body 110. The retainer 120 includes a body portion 121 and one or more (two in this embodiment) restricting portions 122 for restricting movements of the female terminals 31 in the first opposite direction X2. The retainer 120 is, for example, a single component in which the body portion 121 and the restricting portions 122 are continuously and integrally formed. The retainer 120 is, for example, made of synthetic resin.

The body portion 121 is, for example, formed into a frame shape as a whole. The outer peripheral edge of the body portion 121 is, for example, formed to have a rectangular planar shape when viewed from the Z-axis direction. The body portion 121 is, for example, formed to cover an end surface in the third direction Z1 of the tube portion 113.

The body portion 121 includes one or more (two in this embodiment) insertion holes 121X. Each insertion hole 121X penetrates through the body portion 121 in the Z-axis direction. Each insertion hole 121X is formed to communicate with the insertion hole 114 of the tube portion 113. The two insertion holes 121X are, for example, formed to expose the respective opening ends of the tubular connecting portions 60 of the two female terminals 31 accommodated in the housing body 110.

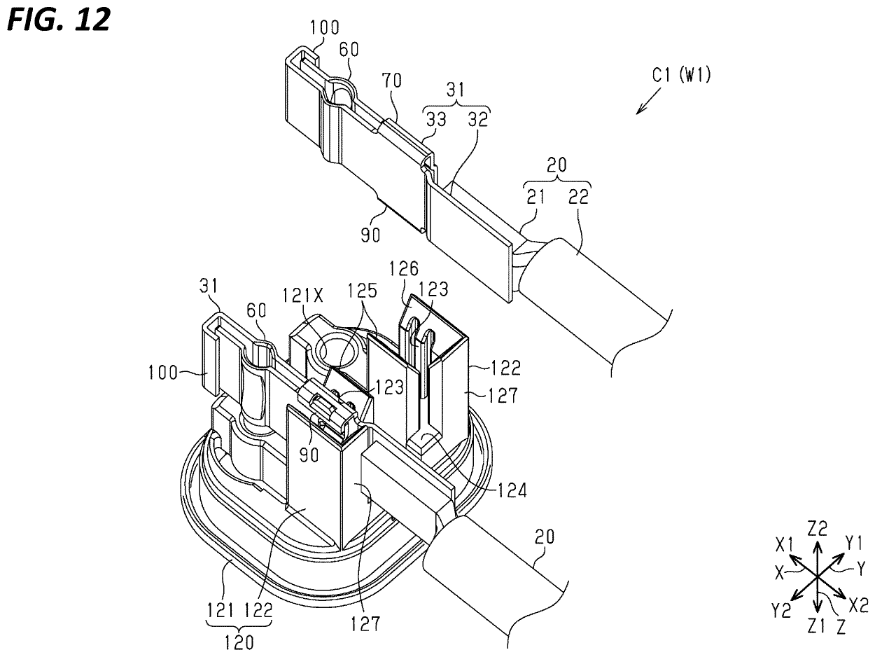

As shown in FIG. 12, the two restricting portions 122 are respectively provided to correspond to the two female terminals 31. The two restricting portions 122 are, for example, provided side by side along the Y-axis direction. Each restricting portion 122 includes, for example, an accommodating portion 123 for accommodating a part of the female terminal 31. Each accommodating portion 123 is, for example, formed into a tubular shape. Each accommodating portion 123 is formed to have a U-shaped transverse cross-sectional shape as a whole. An axial direction of each accommodating portion 123 extends along the X-axis direction. Each accommodating portion 123 is open in the first direction X1 and also in the first opposite direction X2. Each accommodating portion 123 is open in the third opposite direction Z2.

Each female terminal 31 is, for example, inserted into an internal space of each accommodating portion 123 along the third direction Z1. An end part in the first opposite direction X2 of the terminal connecting portion 33 in each female terminal 31 is, for example, accommodated into the internal space of each accommodating portion 123. The two female terminals 31 are, for example, respectively accommodated in the two accommodating portions 123 in orientations different from each other. In particular, the female terminal 31 is accommodated in the accommodating portion 123 provided on the second direction Y1 side, out of the two accommodating portions 123, in such a posture that the winding/pressing portion 90 is facing in the third direction Z1. The female terminal 31 is accommodated in the accommodating portion 123 provided on the second opposite direction Y2 side, out of the two accommodating portions 123, in such a posture that the winding/pressing portion 90 is facing in the third opposite direction Z2. Specifically, the female terminal 31 provided on the second opposite direction Y2 side is accommodated in the accommodating portion 123 in a posture rotated from the female terminal 31 on the second direction Y1 side by 180°. As shown in FIG. 3, each restricting portion 122 is inserted into the housing body 110 along the third opposite direction Z2 when the retainer 120 is mounted into the tube portion 113 of the housing body 110. At this time, each restricting portion 122 is so inserted into the housing body 110 that the female terminal 31 is accommodated into the internal space of the accommodating portion 123.

As shown in FIGS. 12, 13 and 14, each accommodating portion 123 includes a bottom wall 124, a side wall 125 projecting from a first side edge of the bottom wall 124 and a side wall 126 projecting from a second side edge of the bottom wall 124. The first side edge of the bottom wall 124 is facing the bottom wall 124 of the other accommodating portion 123. The second side edge of the bottom wall 124 is provided on a side opposite to the first side edge in the Y-axis direction. The internal space of each accommodating portion 123 is formed by a space surrounded by the bottom wall 124, the side wall 125 and the side wall 126.

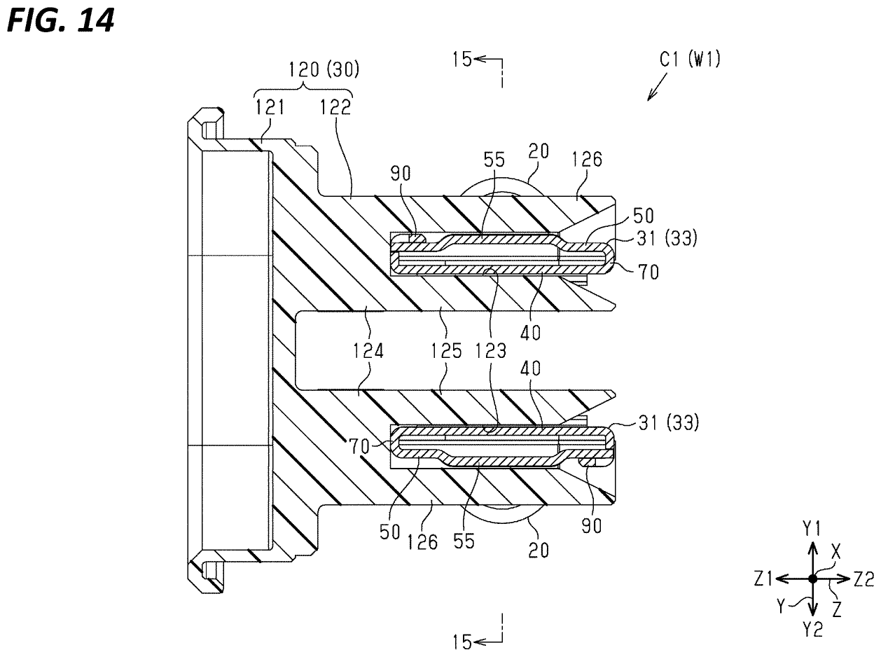

As shown in FIG. 14, each side wall 125, 126 is formed to be continuous and integral with the bottom wall 124. Each side wall 125, 126 projects in the third opposite direction Z2 from the bottom wall 124. Each side wall 125, 126 is, for example, in the form of a plate. The two side walls 125, 126 are, for example, facing each other in a width direction of the bottom wall 124 (here, the Y-axis direction). An end part in the third direction Z1 of the side wall 125 and an end part in the third direction Z1 of the side wall 126 are connected to each other by the bottom wall 124. An end part in the third opposite direction Z2 of the side wall 125 and an end part in the third opposite direction Z2 of the side wall 126 are not connected to each other. In other words, each accommodating portion 123 includes a groove-like internal space open in the third opposite direction Z2.

Each accommodating portion 123 is formed to be able to accommodate the winding/pressing portion 90 and the convex portion 55 of the female terminal 31 inside. An interval between the inner surface of the side wall 125 and that of the side wall 126 is, for example, set to be able to accommodate the winding/pressing portion 90. A shortest distance between the inner surface of the side wall 125 and that of the side wall 126 is set to be slightly larger than a longest distance of the winding/pressing portion 90 along the Y-axis direction. Here, the convex portion 55 of the female terminal 31 is so formed that the first projection amount along the Y-axis direction from the outer surface of the second peripheral wall 50 is equal to the second projection amount along the Y-axis direction of the winding/pressing portion 90. Thus, the convex portion 55 can be suitably accommodated between the inner surface of the side wall 125 and that of the side wall 126. By providing such a convex portion 55, gaps between the female terminal 31 and the inner surfaces of the side walls 125, 126 can be suppressed from becoming larger in a part where the winding/pressing portion 90 is not provided. In this way, the inclination of the female terminal 31 inside each accommodating portion 123 can be suitably suppressed.

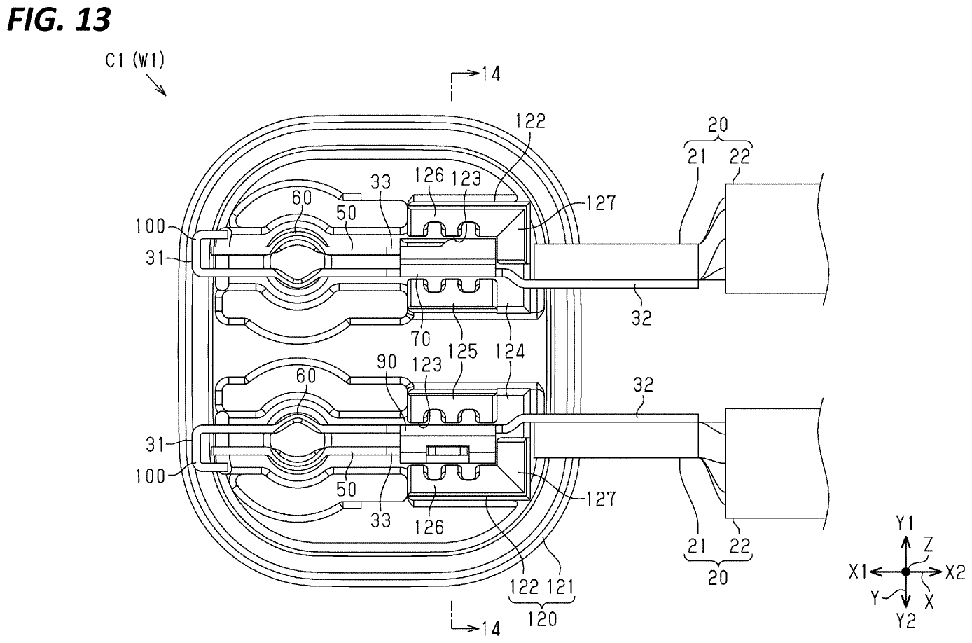

As shown in FIG. 13, each restricting portion 122 includes an engagement wall 127 to be engaged with the female terminal 31. The engagement wall 127 is, for example, provided to close a part of an opening in the first opposite direction X2 of the accommodating portion 123. The engagement wall 127 is, for example, formed to be continuous and integral with the bottom wall 124. The engagement wall 127 is, for example, formed to be continuous and integral with the side wall 126. The engagement wall 127 extends, for example, toward the side wall 125 along the Y-axis direction from an end part in the first opposite direction X2 of the side wall 126. The engagement wall 127 extends up to the side wall 125 in the Y-axis direction.

The engagement wall 127 is provided to be engageable with the end surface in the first opposite direction X2 of the second peripheral wall 50 of the female terminal 31 in the first direction X1 when the retainer 120 is mounted into the housing body 110 (see FIG. 2). The engagement wall 127 restricts a movement of the female terminal 31 in the first opposite direction X2. The restricting portion 122 including such an engagement wall 127 assures the position in the X-axis direction of the female terminal 31 inside the housing body 110 (see FIG. 2).

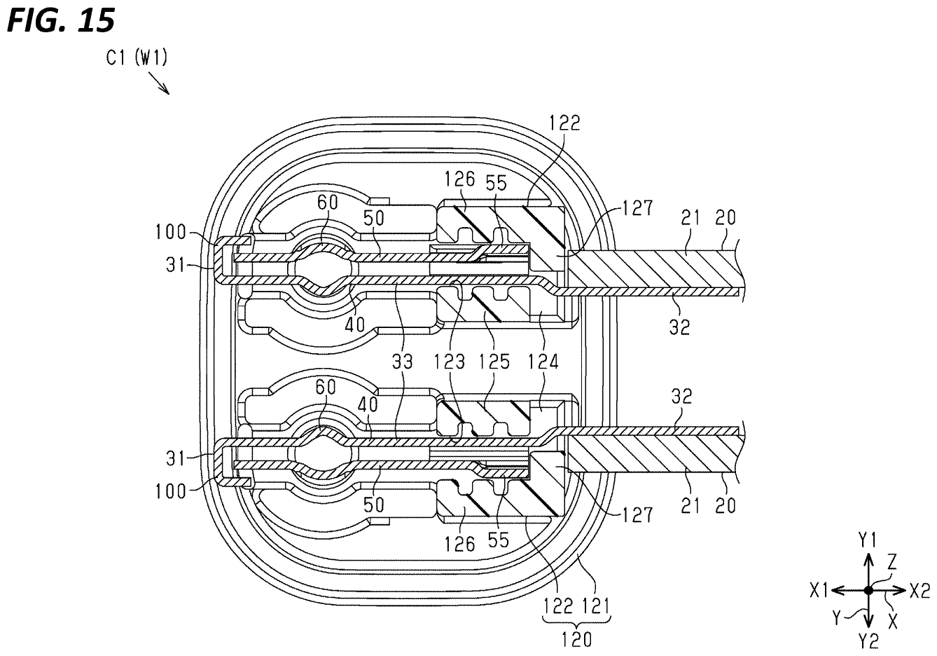

As shown in FIG. 15, the engagement wall 127 is provided to be engageable with the convex portion 55 of the female terminal 31 in the first direction X1 when the retainer 120 is mounted into the housing body 110 (see FIG. 2). The engagement wall 127 is provided to be engageable with the end surface in the first opposite direction X2 of the convex portion 55 in the first direction X1. Here, the convex portion 55 is engaged with an end surface in the first direction X1 in a basis part to be connected to the side wall 126, out of the engagement wall 127. In this way, a movement of the female terminal 31 in the first opposite direction X2 can be suitably suppressed.

Next, functions and effects of this embodiment are described.

(1) The connector C1 is provided with the female terminals 31 and the housing 30 for holding the female terminals 31. The female terminal 31 includes the first peripheral wall 40 having the first tubular portion 41, the second peripheral wall 50 having the second tubular portion 51 facing the first tubular portion 41, and the tubular connecting portion 60 composed of the first and second tube portions 41, 51. The female terminal 31 includes the winding/pressing portion 90 for limiting the separation distance between the first inner surface 42 of the first tubular portion 41 and the second inner surface 52 of the second tubular portion 51 and the convex portion 55 projecting from the outer surface of the second peripheral wall 50. The winding/pressing portion 90 is integrally formed to the first peripheral wall 40. The winding/pressing portion 90 is folded from the first peripheral wall 40 while embracing the end edge of the second peripheral wall 50 inside, and held in contact with the outer surface of the second peripheral wall 50. The winding/pressing portion 90 and the convex portion 55 are provided side by side on the same straight line along the Z axis. The housing 30 includes the groove-like accommodating portions 123, into which the winding/pressing portions 90 and the convex portions 55 are inserted.

According to this configuration, the winding/pressing portion 90 and the convex portion 55 of the female terminal 31 are inserted into the accommodating portion 123 of the housing 30. Here, the winding/pressing portion 90 is folded from the first peripheral wall 40 and held in contact with the outer surface of the second peripheral wall 50. Thus, the winding/pressing portion 90 projects further outward than the outer surface of the second peripheral wall 50. If such a winding/pressing portion 90 is accommodated into the accommodating portion 123, a large gap may be formed between the part of the female terminal 31 where the winding/pressing portion 90 is not formed and the inner surface of the accommodating portion 123. If such a gap is formed, the female terminal 31 is easily displaced inside the accommodating portion 123. Specifically, there is a problem that the female terminal 31 is easily inclined. In contrast, in the above configuration, the convex portion 55 projecting from the outer surface of the second peripheral wall 50 is provided side by side with the winding/pressing portion 90 on the same straight line. By providing this convex portion 55, the gap between the part of the female terminal 31 where the winding/pressing portion 90 is not formed and the inner surface of the accommodating portion 123 can be reduced. In this way, a displacement of the female terminal 31 inside the accommodating portion 123 can be suitably suppressed. Consequently, a displacement of the female terminal 31 inside the housing 30 can be suitably suppressed.

(2) The female terminal 31 is provided with the winding/pressing portion 90 for limiting the separation distance between the first inner surface 42 of the first tubular portion 41 and the second inner surface 52 of the second tubular portion 51. According to this configuration, when the columnar connecting portion 201 of the male terminal 200 is press-fit into the tubular connecting portion 60 of the female terminal 31, the separation distance between the first inner surface 42 of the first peripheral wall 40 and the second inner surface 52 of the second peripheral wall 50 is restricted from increasing by the winding/pressing portion 90. By this limitation by the winding/pressing portion 90, the first and second inner surfaces 42, 52 are maintained in a state biased in directions approaching each other. Thus, the first and second inner surfaces 42, 52 can be suitably brought into contact with the outer peripheral surface of the columnar connecting portion 201. As a result, the tubular connecting portion 60 and the columnar connecting portion 201 can be stably held in a press-contact state. Further, the winding/pressing portion 90 is integrally formed to the first peripheral wall 40. Thus, the tubular connecting portion 60 and the columnar connecting portion 201 can be held in the press-contact state by a simple structure as compared to the case where a separate component such as a coil spring is used. That is, the structure of the female terminal 31 can be simplified as compared to the case where a separate component such as a coil spring is used.

(3) The axial direction of the tubular connecting portion 60 extends along the third direction Z1. The winding/pressing portion 90 is folded from the end surface in the third direction Z1 of the first peripheral wall 40 while embracing the end surface in the third direction Z1 of the second peripheral wall 50 inside. The convex portion 55 is provided to overlap the winding/pressing portion 90 in a plan view viewed from the third direction Z1. The convex portion 55 is formed to project in the second direction Y1 from the outer surface of the second peripheral wall 50. In this way, the gap between the female terminal 31 and the inner surface of the accommodating portion 123 in the second direction Y1 can be reduced. Therefore, the inclination of the female terminal 31 in the second direction Y1 inside the accommodating portion 123 can be suitably suppressed. As a result, the inclination of the axial direction of the tubular connecting portion 60 of the female terminal 31 in the second direction Y1 can be suppressed. Thus, it can be suitably suppressed that the columnar connecting portion 201 of the male terminal 200 is inserted into the tubular connecting portion 60 while being inclined with respect to the axial direction of the tubular connecting portion 60.

(4) The first projection amount of the convex portion 55 along the second direction Y1 from the outer surface of the second peripheral wall 50 is equal to the second projection amount of the winding/pressing portion 90 along the second direction Y1 from the outer surface of the second peripheral wall 50. By providing such a convex portion 55, the gap between the female terminal 31 in the part where the winding/pressing portion 90 is not formed and the inner surface of the accommodating portion 123 can be made smaller. In this way, a displacement of the female terminal 31 inside the accommodating portion 123 can be more suitably suppressed.

(5) The housing 30 includes the housing body 110 for accommodating the female terminals 31 inside and the retainer 120 to be mounted into the housing body 110. The retainer 120 includes the restricting portions 122 to be inserted into the housing body 110 and configured to restrict movements of the female terminals 31. The restricting portion 122 includes the accommodating portion 123. According to this configuration, the accommodating portion 123 is provided in the restricting portion 122 of the retainer 120. Thus, when the retainer 120 is mounted into the housing body 110, displacements of the female terminals 31 inside the accommodating portions 123 of the retainer 120 can be suitably suppressed. Consequently, displacements of the female terminals 31 inside the housing 30 can be suitably suppressed.

(6) The restricting portion 122 includes the engagement wall 127 to be engaged with the convex portion 55 in the first direction X1. According to this configuration, the convex portion 55 of the female terminal 31 is engaged with the engagement wall 127 in the first opposite direction X2. Thus, movements of the female terminals 31 in the first opposite direction X2 inside the accommodating portions 123 can be suitably suppressed.

(7) The first and second peripheral walls 40, 50 are coupled by the coupling portion 70 integrally formed to the both first and second peripheral walls 40, 50. In this way, the first and second peripheral walls 40, 50 can be integrally formed through the coupling portion 70. Thus, the female terminal 31 can be configured, such as by bending one metal plate. As a result, the structure of the female terminal 31 can be simplified.

(8) The winding/pressing portion 90 is provided on the side opposite to the coupling portion 70 across the first peripheral wall 40. Thus, the opening of the coupling portion 70, i.e. an increase in separation distance between the first and second peripheral walls 40, 50 can be suitably limited by the winding/pressing portion 90. As a result, an increase in separation distance between the first and second inner surfaces 42, 52 can be suitably limited by the winding/pressing portion 90.

(9) The projection amount P1 of the winding/pressing portion 90 folded from the end surface in the third direction Z1 of the first peripheral wall 40 toward the second peripheral wall 50 is equal to the projection amount P2 of the coupling portion 70 folded from the end surface in the third opposite direction Z2 of the first peripheral wall 40 toward the second peripheral wall 50. Thus, the winding/pressing portion 90 and the coupling portion 70 can be formed into nearly symmetrical shapes. In this way, the female terminal 31 can be accommodated even if the winding/pressing portion 90 is in a posture facing the space capable of accommodating the winding/pressing portion 90, i.e. the internal space of the accommodating portion 123 or the coupling portion 70 is in a posture facing the internal space. As a result, the limitation of the insertion direction of the female terminal 31 into the interna space of the accommodating portion 123 can be mitigated. Therefore, the versatility of the female terminal 31 can be improved.

(10) The protection wall 102 of the protecting portion 100 integrally formed to the first peripheral wall 40 is provided to face the end part in the first direction X1 of the second peripheral wall 50 while being separated from this end part. Thus, the deformation of the second peripheral wall 50 can be suitably hindered by the protection wall 102, for example, even if an excessive external force is accidentally applied to the end part in the first direction X1 of the second peripheral wall 50 and the second peripheral wall 50 is deformed away from the first peripheral wall 40 due to that external force.

(11) The winding/pressing portion 90 is provided on the end part in the first opposite direction X2 of the first peripheral wall 40. The tubular connecting portion 60 is provided at the intermediate position between the winding/pressing portion 90 and the protecting portion 100 in the first direction X1. According to this configuration, the winding/pressing portion 90 is provided at a position different from the tubular connecting portion 60 in the first direction X1. An increase in separation distance between the first and second peripheral walls 40, 50 can be limited by such a winding/pressing portion 90. Consequently, an increase in separation distance between the first inner surface 42 constituting the tubular connecting portion 60 and the second inner surface 52 constituting the tubular connecting portion 60 can be limited by the winding/pressing portion 90.

(12) The wire connecting portion 32 to be electrically connected to the wire 20 is integrally formed to the first peripheral wall 40. Thus, the number of components of the female terminal 31 can be reduced and the structure of the female terminal 31 can be simplified.

(13) The tubular connecting portion 60 includes the plurality of linear contact portions 43 projecting radially inwardly of the tubular connecting portion 60 from the first inner surface 42 and provided away from each other in the circumferential direction of the tubular connecting portion 60. The linear contact portions 43 extend along the axial direction of the tubular connecting portion 60. According to this configuration, when the columnar connecting portion 201 of the male terminal 200 is press-fit into the tubular connecting portion 60, the linear contact portions 43 provided on the first inner surface 42 constituting the tubular connecting portion 60 are pressed into line contact with the outer peripheral surface of the columnar connecting portion 201 at a plurality of positions separated in the circumferential direction. In this way, for example, even if a swinging movement is transmitted to the male terminal 200, a displacement of the male terminal 200 due to that swinging movement can be hindered by the contact of the male terminal 200 with the plurality of linear contact portions 43.

(14) The second inner surface 52 is formed to be arcuately recessed radially outwardly of the tubular connecting portion 60 in a cross-section. The tubular connecting portion 60 includes the protrusion 54 arcuately projecting radially inwardly of the tubular connecting portion 60 from the second inner surface 52 in a cross-section. According to this configuration, when the columnar connecting portion 201 of the male terminal 200 is press-fit into the tubular connecting portion 60, the protrusion 54 arcuately projecting radially inwardly from the second inner surface 52 constituting the tubular connecting portion 60 is pressed into contact with the outer peripheral surface of the columnar connecting portion 201. In this way, since the protrusion 54 can be pressed into contact with the outer peripheral surface of the columnar connecting portion 201 with a high contact pressure, the tubular connecting portion 60 and the columnar connecting portion 201 can be stably held in the press-contact state.

### Other Embodiments

The above embodiment can be modified and carried out as follows. The above embodiment and the following modifications can be combined with each other and carried out without technically contradicting.

The structure of the female terminal 31 in the above embodiment can be changed as appropriate.

The size of the convex portion 55 of the female terminal 31 may be changed as appropriate. For example, the length along the X-axis direction of the convex portion 55 may be changed. For example, the convex portion 55 may be formed to extend up to the vicinity of the tubular connecting portion 60 in the X-axis direction.

Although the gap between the female terminal 31 and the inner surface of the accommodating portion 123 is reduced by providing the female terminal 31 with the convex portion 55 in the above embodiment, there is no limitation to this. For example, the gap between the female terminal 31 and the inner surface of the accommodating portion 123 may be reduced by providing a convex portion projecting toward the outer surface of the second peripheral wall 50 on the inner surface of the accommodating portion 123.

Although the protecting portion 100 is integrally formed to the first peripheral wall 40 in the above embodiment, there is no limitation to this. For example, the protecting portion 100 may be integrally formed to the second peripheral wall 50. The protecting portion 100 in this case is, for example, formed to be folded from the end part in the first direction X1 of the second peripheral wall 50 while arranging the end part in the first direction X1 of the first peripheral wall 40 inside.

The protecting portion 100 of the female terminal 31 may be omitted.

The guiding portions 61 in the tubular connecting portion 60 of the female terminal 31 may be omitted.

Three or more linear contact portions 43 may be provided on the first inner surface 42 of the first tubular portion 41 of the female terminal 31.

The plurality of linear contact portions 43 and the protrusion 54 having an arcuate cross-section may be provided on the first inner surface 42 of the female terminal 31.

Although the plurality of linear contact portions 43 are provided on the first inner surface 42 of the first tubular portion 41 and the protrusion 54 having an arcuate cross-section is provided on the second inner surface 52 of the second tubular portion 51 in the above embodiment, there is no limitation to this. For example, the protrusion 54 having an arcuate cross-section may be provided on the first inner surface 42 and the plurality of linear contact portions 43 may be provided on the second inner surface 52. For example, linear contact portions 43 may be provided on the both first and second inner surfaces 42, 52. For example, protrusions 54 having an arcuate cross-section may be provided on the both first and second inner surfaces 42, 52.

The position of the winding/pressing portion 90 in the female terminal 31 may be changed as appropriate. For example, the winding/pressing portion 90 may be provided at a position different from the coupling portion 70 in the X-axis direction.

Although the wire connecting portion 32 is integrally formed to the first peripheral wall 40 in the above embodiment, there is no limitation to this. For example, the wire connecting portion 32 may be integrally formed to the second peripheral wall 50.

In the female terminal 31 of the above embodiment, only the terminal connecting portion 33, out of the wire connecting portion 32 and the terminal connecting portion 33, is structured by folding the second peripheral wall 50 into two on the first peripheral wall 40. Without limitation to this, for example, both the wire connecting portion 32 and the terminal connecting portion 33 may be structured by folding two plate materials.

Although the retainer 120 is provided with the accommodating portions 123, into which the winding/pressing portions 90 and the convex portions 55 are inserted, in the above embodiment, there is no limitation to this. For example, the housing body 110 may be provided with the accommodating portions 123.

The structure of the housing body 110 in the above embodiment can be changed as appropriate. For example, if the housing body 110 is structured to be able to accommodate the female terminals 31, other structures can be changed as appropriate.

The structure of the retainer 120 in the above embodiment can be changed as appropriate. For example, the engagement wall 127 may be omitted.

Although the columnar connecting portion 201 of the male terminal 200 is embodied to have a cylindrical shape in the above embodiment, there is no limitation to this. For example, the columnar connecting portion 201 may be formed into a columnar shape other than the cylindrical shape. For example, a transverse cross-sectional shape of the columnar connecting portion 201 may be formed into an elliptical shape or a polygonal shape.

As shown in FIGS. 9, 11 and 14, the convex portion 55 of the female terminal 31 according to the non-limiting embodiment can have an elongated top surface having a length (Z), a width (X) and a height (Y). This elongated top surface may be a flat surface (XZ surface). One convex portion 55 of the female terminal 31 can be sufficient. As shown in FIG. 14, the accommodating portion 123 of the housing 30 according to the non-limiting embodiment may have one or more innermost support surfaces (side wall 125) configured to reduce the rattling of the female terminal 31 with respect to the housing 30 by direct contact with the elongated top surface of the convex portion 55 over the length (Z) of the elongated top surface of the convex portion 55 of the female terminal 31 when the female terminal 31 is mounted into the housing 30.

As shown in FIGS. 4 to 7, the columnar connecting portion 201 of the male terminal 200 according to the non-limiting embodiment is an example of an electrically conductive straight rod having a longitudinal axis (arrow Z in figures), an axial length and a radial thickness. This electrically conductive straight rod may have a smooth side surface as shown in FIG. 7 and may be, for example, a cylindrical rod having a substantially circular cross-section.

As shown in FIGS. 4 to 7, the tubular connecting portion 60 of the female terminal 31 according to the non-limiting embodiment of the present disclosure may be configured to include or define a straight hole having a longitudinal axis (arrow Z in figures) to receive the columnar connecting portion 201 of the male terminal 200. For example, the tubular connecting portion 60 may include the tubular portion 41 with a first straight groove (inner surface 42) having a first groove length and the tubular portion 51 with a second straight groove (inner surface 52) having a second groove length possibly equal to the first groove length. As shown in FIG. 7, the straight hole of the tubular connecting portion 60 may be defined between the first straight groove (inner surface 42) of the tubular portion 41 and the second straight groove (inner surface 52) of the tubular portion 51.

As shown in FIGS. 7 and 8, the plurality of linear contact portions 43 of the female terminal 31 of the non-limiting embodiment may be provided at a plurality of first angular positions or first circumferential positions around the longitudinal axis (Z) of the tubular connecting portion 60 of the female terminal 31 (see FIG. 7). Each of the plurality of linear contact portions 43 may extend straight without any interruption along the longitudinal axis (Z) of the tubular connecting portion 60 of the female terminal 31. A subset of the plurality of linear contact portions 43 may be referred to as a subset of linear seat portions discrete in the circumferential direction and configured to support the side surface of the columnar connecting portion 201 of the male terminal 200 at the plurality of first angular positions. The subset of the plurality of linear contact portions 43 may be referred to as a plurality of first pressure positions discrete in the circumferential direction and configured to pressurize the side surface of the columnar connecting portion 201 of the male terminal 200 radially inwardly at the plurality of first angular positions.

As shown in FIG. 9, the protrusion 54 of the female terminal 31 of the non-limiting embodiment may be provided at a second angular position or a second circumferential position around the longitudinal axis (Z) of the tubular connecting portion 60 of the female terminal 31 (see FIG. 7). This protrusion 54 may be referred to as a second pressure position configured to pressurize the side surface of the columnar connecting portion 201 of the male terminal 200 radially inwardly at the second angular position.

The embodiment disclosed this time should be considered illustrative in all aspects, rather than restrictive. The scope of the present invention is represented not by the above meaning, but by claims and is intended to include all changes in the scope of claims and in the meaning and scope of equivalents.

### LIST OF REFERENCE NUMERALS

20 . . . wire, 21 . . . core wire, 22 . . . insulation coating, 30 . . . housing, 31 . . . female terminal, 32 . . . wire connecting portion, 33 . . . terminal connecting portion, 40 . . . first peripheral wall, 41 . . . first tubular portion, 42 . . . first inner surface, 43 . . . linear contact portion, 50 . . . second peripheral wall, 51 . . . second tubular portion, 52 . . . second inner surface, 53 . . . dent portion, 54 . . . protrusion, 55 . . . convex portion, 56 . . . concave portion, 60 . . . tubular connecting portion, 61 . . . guiding portion, 70 . . . coupling portion, 71, 72 . . . extending portion, 73 . . . folded portion, 80 . . . projecting portion, 81 . . . projecting base portion, 82 . . . projection, 90 . . . winding/pressing portion, 91 . . . extending portion, 92 . . . folded portion, 93 . . . pressing portion, 94 . . . facing surface, 95 . . . through hole, 96 . . . engagement surface, 100 . . . protecting portion, 101 . . . extending portion, 102 . . . protection wall, 110 . . . housing body, 111 . . . opening, 112 . . . peripheral wall, 113 . . . tube portion, 114 . . . insertion hole, 120 . . . retainer, 121 . . . body portion, 121X . . . insertion hole, 122 . . . restricting portion, 123 . . . accommodating portion, 124 . . . bottom wall, 125, 126 . . . side wall, 127 . . . engagement wall, 200 . . . male terminal, 201 . . . columnar connecting portion, W1 . . . wiring harness, C1 . . . connector, P1, P2 . . . projection amount, X1 . . . first direction, X2 . . . first opposite direction, Y1 . . . second direction, Y2 . . . second opposite direction, Z . . . Z axis (first axis), Z1 . . . third direction, Z2 . . . third opposite direction

1. A connector, comprising a female terminal and a housing for holding the female terminal,
the female terminal including:
a first peripheral wall having a first tubular portion;
a second peripheral wall having a second tubular portion facing the first tubular portion;
a tubular connecting portion composed of the first tubular portion and the second tubular portion;
a winding/pressing portion for limiting a separation distance between a first inner surface of the first tubular portion and a second inner surface of the second tubular portion; and
a convex portion projecting from an outer surface of the second peripheral wall,
the winding/pressing portion being integrally formed to the first peripheral wall,
the winding/pressing portion being folded from the first peripheral wall while embracing an end edge of the second peripheral wall inside, the winding/pressing portion being held in contact with the outer surface of the second peripheral wall,
the winding/pressing portion and the convex portion being provided side by side on the same straight line along a first axis, and
the housing including a groove-like accommodating portion, the winding/pressing portion and the convex portion being inserted into the accommodating portion.

2. The connector of claim 1, wherein:
the first peripheral wall is formed into a strip shape extending along a first direction,
the second peripheral wall is formed into a strip shape extending along the first direction,
the first inner surface is a surface facing in a second direction intersecting the first direction,
the second inner surface is a surface facing in a second opposite direction opposite to the second direction,
the outer surface of the second peripheral wall is a surface facing in the second direction,
an axial direction of the tubular connecting portion extends along a third direction intersecting both the first direction and the second direction,
the winding/pressing portion is folded from an end surface in the third direction of the first peripheral wall while embracing an end surface in the third direction of the second peripheral wall inside,
the convex portion is provided to overlap the winding/pressing portion in a plan view viewed from the third direction, and
the convex portion projects in the second direction from the outer surface of the second peripheral wall.

3. The connector of claim 2, wherein a first projection amount of the convex portion from the outer surface of the second peripheral wall is equal to a second projection amount of the winding/pressing portion from the outer surface of the second peripheral wall.

4. The connector of claim 2, wherein:
the housing includes a housing body for accommodating the female terminal inside and a retainer to be mounted into the housing body,
the retainer includes a restricting portion to be inserted into the housing body, the restricting portion restricting a movement of the female terminal, and
the restricting portion includes the accommodating portion.

5. The connector of claim 4, wherein the restricting portion includes an engagement wall to be engaged with the convex portion in the first direction.

6. The connector of claim 2, wherein:
the female terminal further includes a coupling portion coupling the first peripheral wall and the second peripheral wall, and
the coupling portion is integrally formed to the first peripheral wall and integrally formed to the second peripheral wall.

7. The connector of claim 6, wherein:
the coupling portion is formed to extend in the second direction from an end surface in a third opposite direction opposite to the third direction, out of the first peripheral wall, toward an end surface in the third opposite direction, out of the second peripheral wall, and
the coupling portion is provided to overlap the winding/pressing portion in a plan view viewed from the third direction.

8. The connector of claim 2, wherein:
the female terminal further includes a protecting portion provided on an end part in the first direction of the first peripheral wall,
the protecting portion is integrally formed to the first peripheral wall,
the protecting portion is formed to be folded from the end part in the first direction of the first peripheral wall while arranging an end part in the first direction of the second peripheral wall inside,
the protecting portion includes a protection wall provided to face the end part in the first direction of the second peripheral wall in the second direction, and
the protection wall is provided away from the end part in the first direction of the second peripheral wall.

9. The connector of claim 8, wherein:
the winding/pressing portion is provided on an end part in a first opposite direction opposite to the first direction, out of the first peripheral wall,
the convex portion is provided on an end part in the first opposite direction, out of the second peripheral wall, and
the tubular connecting portion is provided at an intermediate position between the winding/pressing portion and the protecting portion in the first direction.

10. A female terminal, comprising:
a first peripheral wall having a first tubular portion;
a second peripheral wall having a second tubular portion facing the first tubular portion;
a tubular connecting portion composed of the first tubular portion and the second tubular portion;
a winding/pressing portion for limiting a separation distance between a first inner surface of the first tubular portion and a second inner surface of the second tubular portion; and
a convex portion projecting from an outer surface of the second peripheral wall,
the winding/pressing portion being integrally formed to the first peripheral wall,
the winding/pressing portion being folded from the first peripheral wall while embracing an end edge of the second peripheral wall inside, the winding/pressing portion being held in contact with the outer surface of the second peripheral wall, and
the winding/pressing portion and the convex portion being provided side by side on the same straight line along a first axis.
